(19) United States
(12) Patent Application Publication
(10) Pub. No.: US 2014/0159624 A1
(43) Pub. Date: Jun. 12, 2014

(54) MOTOR DRIVING CONTROL APPARATUS AND METHOD, AND MOTOR USING THE SAME

(71) Applicant: SAMSUNG ELECTRO-MECHANICS CO., LTD., Suwon (KR)

(72) Inventor: Joo Yul KO, Suwon (KR)

(73) Assignee: SAMSUNG ELECTRO-MECHANICS CO., LTD., Suwon (KR)

(21) Appl. No.: 13/772,168

(22) Filed: Feb. 20, 2013

(30) Foreign Application Priority Data
Dec. 6, 2012 (KR) 10-2012-0140923

(51) Int. Cl. H02P 6/18

(52) U.S. Cl. CPC H02P 6/182
USPC 318/400.13

(57) ABSTRACT

There are a motor driving control apparatus and method, and a motor using the same, the motor driving control apparatus including a back-electromotive force detecting unit detecting back-electromotive force generated from a motor apparatus, an offset correcting unit determining whether an offset delay is present in the back-electromotive force detecting unit and correcting the offset delay when the offset delay is present, and a controlling unit controlling a driving of the motor apparatus using the back-electromotive force in which the offset delay is corrected by the offset correcting unit.

### CROSS-REFERENCE TO RELATED APPLICATIONS

This application claims the priority of Korean Patent Application No. 10-2012-0140923 filed on Dec. 6, 2012, in the Korean Intellectual Property Office, the disclosure of which is incorporated herein by reference.

### BACKGROUND OF THE INVENTION

1. Field of the Invention

The present invention relates to a motor driving control apparatus and method, and a motor using the same.

2. Description of the Related Art

In accordance with the development of motor technology, motors having various sizes have been used in a wide range of fields.

Generally, a motor is driven by rotating a rotor using a permanent magnet and a coil having polarities changed according to current applied thereto. Initially, a brush type motor in which a rotor is provided with a coil was provided. However, such a motor has a problem such as brush abrasion, spark generation, and the like, caused by the driving thereof.

Therefore, recently, various types of brushless motors have been in general use. Brushless motors, direct current (DC) motors driven using an electronic rectifying tool instead of mechanical contacts such as a brush, a commutator, and the like, may include a rotor formed of a permanent magnet and a rotor including coils corresponding to a plurality of phases and rotated by magnetic force generated by phase voltages in the respective coils.

In order for the brushless motor to be efficiently driven, commutation of the respective phases (coils) of a stator should be performed at an appropriate point. In addition, in order to perform appropriate commutation, a position of the rotor should be recognized.

In order to detect the position of the rotor, according to the related art, an element such as a hall sensor, a resolver, or the like, has been used. However, in this case, there is a limitation that a driving circuit may be complicated.

In order to address this limitation, a technology of detecting a position of a phase using back-electromotive force (BEMF) instead of a sensor to drive a brushless motor has been widely used.

A circuit detecting back-electromotive force according to the related art has necessarily used a comparator. That is, a comparator comparing a phase voltage and a neutral point voltage with each other is necessarily used in the circuit detecting the back-electromotive circuit.

However, the comparator has an offset delay due to an influence, or the like, of a manufacturing process. In addition, offset delays may not be constantly generated, but may be differently determined in each comparator.

Therefore, in the motor control scheme according to the related scheme, there is a limitation that the offset delay due to the comparator may not be corrected.

The following Related Art Documents, which relate to the motor technology as described above, have a limitation that they do not solve the above-mentioned limitations.

### RELATED ART DOCUMENT

(Patent Document 1) Korean Patent Laid-Open Publication No. 2007-0079857
(Patent Document 2) Korean Patent Laid-Open Publication No. 2006-0089482

### SUMMARY OF THE INVENTION

An aspect of the present invention provides a motor driving control apparatus and method capable of more accurately controlling a motor apparatus using back-electromotive force in which an offset delay is corrected by detecting the offset delay of a comparator using a standard voltage having a constant gradient and actively correcting the offset delay, and a motor using the same.

According to an aspect of the present invention, there is provided a motor driving control apparatus including: a back-electromotive force detecting unit detecting back-electromotive force generated from a motor apparatus; an offset correcting unit determining whether an offset delay is present in the back-electromotive force detecting unit and correcting the offset delay when the offset delay is present; and a controlling unit controlling a driving of the motor apparatus using the back-electromotive force in which the offset delay is corrected by the offset correcting unit.

The back-electromotive force detecting unit may include a comparator receiving first and second signals, comparing the first and second signals with each other, and outputting a comparison result.

The offset correcting unit may correct the offset delay generated by the comparator.

The offset correcting unit may include a standard voltage generator generating a linear standard voltage having a constant gradient and providing the linear standard voltage as the first signal, and the second signal may be maintained to have a preset value.

The offset correcting unit may include: a standard voltage generator generating a linear standard voltage having a constant gradient and providing the linear standard voltage as the first signal; and an offset controller detecting the offset delay of the comparator using a change in output of the comparator over time.

The offset correcting unit may further include a variable resistor connected to an input terminal of the comparator, and the offset controller may change a resistance value of the variable resistor according to the detected offset delay.

The variable resistor may include: a first variable resistor connected to a first input terminal of the comparator to which the first signal is input; and a second variable resistor connected to a second input terminal of the comparator to which the second signal is input.

The offset correcting unit may further include a switch switched such that one of the standard voltage and a phase voltage of the motor apparatus is input as the first signal, and the offset controller controls the switch such that the phase voltage is input as the first signal when the correction of the offset delay is completed.

According to another aspect of the present invention, there is provided a motor including: a motor apparatus performing a rotation operation according to a driving control signal; and a motor driving control apparatus correcting an offset delay of a comparator for detecting back-electromotive force generated from the motor apparatus and generating the driving control signal using the back-electromotive force output from the comparator of which the offset delay is corrected.

The motor driving control apparatus may include: a back-electromotive force detecting unit detecting the back-electromotive force generated from the motor apparatus using the comparator; an offset correcting unit calculating the offset delay of the comparator and correcting the offset delay when the offset delay is present; and a controlling unit controlling a driving of the motor apparatus using the back-electromotive force in which the offset delay is corrected by the offset correcting unit.

The offset correcting unit may include: a standard voltage generator generating a linear standard voltage having a constant gradient and providing the linear standard voltage to the comparator; and an offset controller detecting the offset delay of the comparator using a change in the output of the comparator over time.

The offset correcting unit may further include a variable resistor connected to an input terminal of the comparator, and the offset controller changes a resistance value of the variable resistor according to the detected offset delay.

The offset correcting unit may further include a switch switched such that one of the standard voltage and a phase voltage of the motor apparatus is input to the comparator, and the offset controller controls the switch such that the phase voltage is input to the comparator when the correction of the offset delay is completed.

According to another aspect of the present invention, there is provided a motor driving control method performed by a motor driving control apparatus controlling driving of a motor apparatus, the motor driving control method including: generating a linear standard voltage having a constant gradient; determining an offset delay of a comparator by using an output of the comparator receiving a reference voltage maintained to have a preset value and the standard voltage; and correcting the offset delay of the comparator when the offset delay is present.

The motor driving control method may further include detecting back-electromotive force for the motor apparatus from the comparator of which the offset delay is corrected and generating a driving control signal for the motor apparatus using the detected back-electromotive force.

The determining of the offset delay may include: detecting the output of the comparator receiving the reference voltage maintained to have the preset value and the standard voltage; and determining the offset delay using a change in the output for a predetermined standard unit time.

The standard voltage may be a voltage increased to a preset first voltage while having a constant gradient, and the reference voltage may correspond to ½ that of the first voltage.

The determining of the offset delay using the change in the output may include: comparing a first point at which an output value of the comparator is changed and a second point at which the standard voltage arrives at the first voltage with each other; and determining that the offset delay is present when the first point does not correspond to ½ of the second point.

The correcting of the offset delay may include changing a resistance value of a variable resistor connected to an input terminal of the comparator to correct the offset delay.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram illustrating an example of a motor driving control apparatus;

FIG. 2 is a schematic circuit diagram illustrating an example of a back-electromotive force detecting unit of FIG. 1;

FIG. 3 is a configuration diagram illustrating an example of a motor driving control apparatus according to an embodiment of the present invention;

FIG. 4 is a detailed configuration diagram illustrating an example of an offset correcting unit of FIG. 3;

FIGS. 5 and 6 are reference graphs for describing offset correction by the offset correcting unit of FIG. 3; and

FIG. 7 is a flow chart for describing an example of a motor driving control method according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Hereinafter, for convenience of explanation, the present invention will be described based on a brushless motor. However, since this is for convenience of explanation, it is obvious that the scope of the present invention is not necessarily limited to a brushless motor.

In addition, hereinafter, a motor itself will be known as a motor apparatus 20 or 200, and an apparatus including a motor driving control apparatus 10 or 100 for driving the motor apparatus 20 or 200 and the motor apparatus 20 or 200 will be known as a motor.

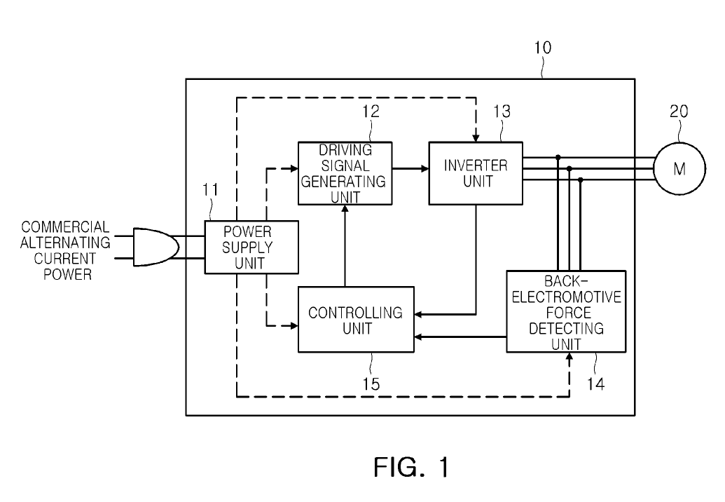

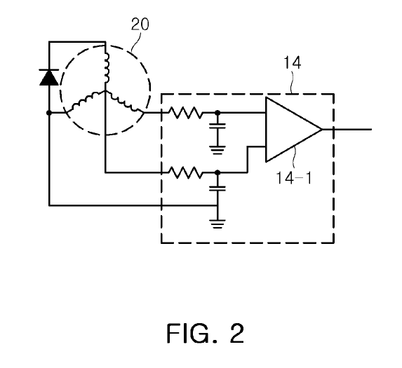

FIG. 1 is a configuration diagram for describing an example of a motor driving control apparatus; and FIG. 2 is a schematic circuit diagram for describing an example of a back-electromotive force detecting unit of FIG. 1.

Referring to FIGS. 1 and 2, the motor driving control apparatus 10 may include a power supply unit 11, a driving signal generating unit 12, an inverter unit 13, a back-electromotive force detecting unit 14, and a controlling unit 15.

The power supply unit 11 may supply power to the respective components of the motor driving control apparatus 10. For example, the power supply unit 11 may convert a commercial alternating current (AC) voltage into a direct current (DC) voltage and supply the DC voltage to the respective components. In the example shown in FIG. 1, a dotted line denotes that predetermined power is supplied from the power supply unit 11.

The driving signal generating unit 12 may provide a driving control signal to the inverter unit 13.

In the embodiment of the present invention, the driving control signal may be a pulse width modulation (PWM) signal. In this case, the driving signal generating unit 12 may apply a variable DC level to a predetermined standard waveform (for example, a triangular wave) to adjust a duty ratio of the PWM signal.

The inverter unit 13 may allow the motor apparatus 20 to be operated. For example, the inverter unit 13 may convert the DC voltage into a multiphase (for example, a three-phase or a four-phase) voltage according to the driving control signal and apply the multiphase voltage to each of the coils (corresponding to the plurality of phases) of the motor apparatus 20, thereby allowing a rotor of the motor apparatus 200 to be operated.

The back-electromotive force detecting unit 14 may detect back-electromotive force of the motor apparatus 20. In the case in which the motor apparatus 20 is rotated, back-electromotive force is generated in the coils provided in the rotor. More specifically, back-electromotive force may be generated in the coils to which the phase voltage is not applied among a plurality of coils, and the back-electromotive force detecting unit 14 may detect back-electromotive force generated in the respective coils of the motor apparatus 20 and provide the detected back-electromotive force to the controlling unit 15.

The controlling unit 15 may control the driving signal generating unit 12 to generate the driving control signal using the back-electromotive force provided from the back-electromotive force detecting unit 14. For example, the controlling unit 15 may control the driving signal generating unit 12 to perform phase commutation at a zero-crossing point of the back-electromotive force.

The motor apparatus 20 may perform a rotation operation according to the driving control signal. For example, magnetic fields may be generated in the respective coils of the motor apparatus 20 by a driving current provided from the inverter unit 13. The rotor included in the motor apparatus 20 may be rotated by the magnetic fields generated in the coils as described above.

FIG. 2 is a schematic circuit diagram illustrating an example of a back-electromotive force detecting unit of FIG. 1.

The motor apparatus 20 shown in FIG. 2 may include a three-phase coil and directly obtain a voltage from a neutral point of the three-phase coil. However, in another example, the motor apparatus does not directly obtain the voltage from the neutral point, but may also obtain a virtual neutral point voltage from the three-phase coil.

As an example, the back-electromotive force detecting unit 14 may allow each of detected pole voltage and neutral point voltage to pass through a low pass filter configured of a resistor and a capacitor and compare the pole voltage and the neutral point voltage passing through the low pass filter with each other using a comparator 14-1 to detect the back-electromotive force. The low pass filter as described above may be used to filter the driving control signal. Therefore, the low pass filter as described above is not a necessary component. That is, in another example, the back-electromotive force detecting unit 14 may be configured not to include the low pass filter.

However, the back-electromotive force detecting unit 14 may not correct an offset delay generated by the comparator 14-1. More specifically, in the comparator 14-1, a delay (offset delay) phenomenon in which a phase of an output value lags or leads is generated due to an offset voltage. However, in the shown example, the offset delay as described above may not be corrected.

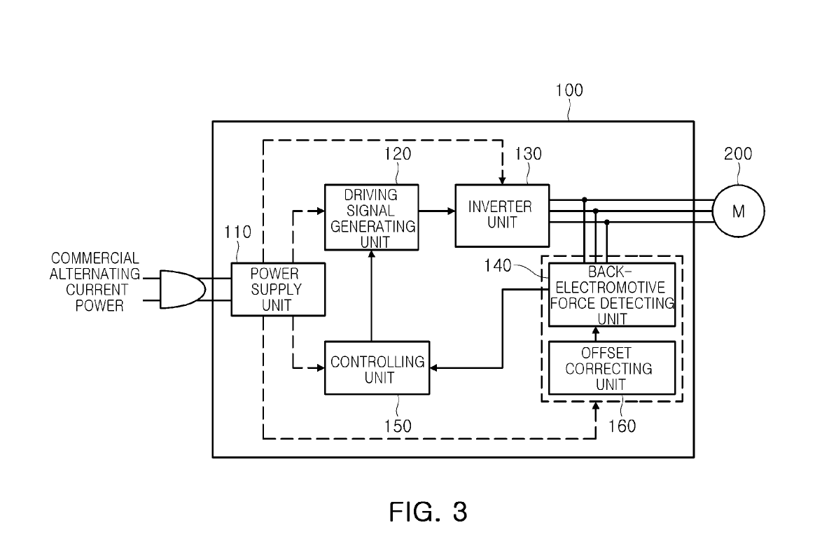

Hereinafter, various embodiments of the present invention will be described with reference to FIGS. 3 through 8. Various embodiments of the present invention to be described below relate to embodiments capable of correcting an offset delay generated by a comparator itself.

In a description for various embodiments of the present invention to be described below, an overlapped description for contents that are the same as or correspond to contents described above with reference to FIGS. 1 and 2 will be omitted. However, those skilled in the art may clearly understand detailed contents of the present invention from the above-mentioned description.

FIG. 3 is a configuration diagram for describing an example of a motor driving control apparatus according to an embodiment of the present invention.

Referring to FIG. 3, the motor driving control apparatus 100 may include a power supply unit 110, a driving signal generating unit 120, an inverter unit 130, a back-electromotive force detecting unit 140, a controlling unit 150, and an offset correcting unit 160.

The power supply unit 110 may supply power to the respective components of the motor driving control apparatus 100.

The driving signal generating unit 120 may generate a driving control signal of the motor apparatus 200 according to a control of the controlling unit 150. For example, the driving signal generating unit 120 may generate a pulse width modulation signal (hereinafter, referred to as a PWM signal) having a predetermined duty ratio and provide the PWM signal to the inverter unit 130 to allow the motor apparatus 200 to be driven.

The inverter unit 130 may provide a driving current to each of the plurality of phases of the motor apparatus 200 according to the driving control signal.

The back-electromotive force detecting unit 140 may detect back-electromotive force generated from the motor apparatus 200.

In the embodiment of the present invention, the back-electromotive force detecting unit 140 may include a comparator 140. The comparator may receive first and second signals, compare the first and second signals with each other, and output a comparison result. For example, the comparator may receive a phase voltage and a neutral point voltage as the first and second signals and compare the phase voltage and the neutral point voltage with each other, and output back-electromotive force.

In the embodiment of the present invention, the back-electromotive force detecting unit 140 may detect the back-electromotive force using the comparators connected to the plurality of phases of the motor apparatus 200, respectively.

In the embodiment of the present invention, the back-electromotive force detecting unit 140 may detect the back-electromotive force using the comparator connected to a phase that is not currently operated. The reason is that in the case in which a rotor is rotated by a phase to which the driving current is currently provided, back-electromotive force is induced in the phase that is not currently operated.

The controlling unit 150 may receive the back-electromotive force in which an offset delay is corrected by the offset correcting unit 160 from the back-electromotive force detecting unit 140. The controlling unit 150 may control the driving signal generating unit 120 to generate the driving control signal using the received back-electromotive force. For example, the controlling unit 150 may control the driving signal generating unit 120 to perform phase commutation at a zero-crossing point of the back-electromotive force.

The offset correcting unit 160 may determine whether or not the offset delay is present in the back-electromotive force detecting unit 140 and correct the offset delay when it is determined that the offset delay is present in the back-electromotive force detecting unit 140. For example, in the example of the back-electromotive force detecting unit 140 including the comparator, the offset correcting unit 160 may correct the offset delay of the comparator included in the back-electromotive force detecting unit 140.

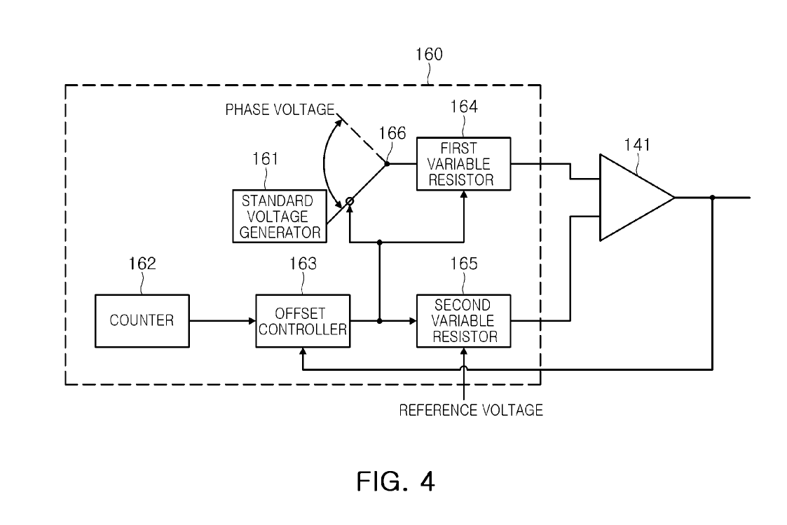

Hereinafter, an example of the offset correcting unit will be described in more detail with reference to FIGS. 4 through 6.

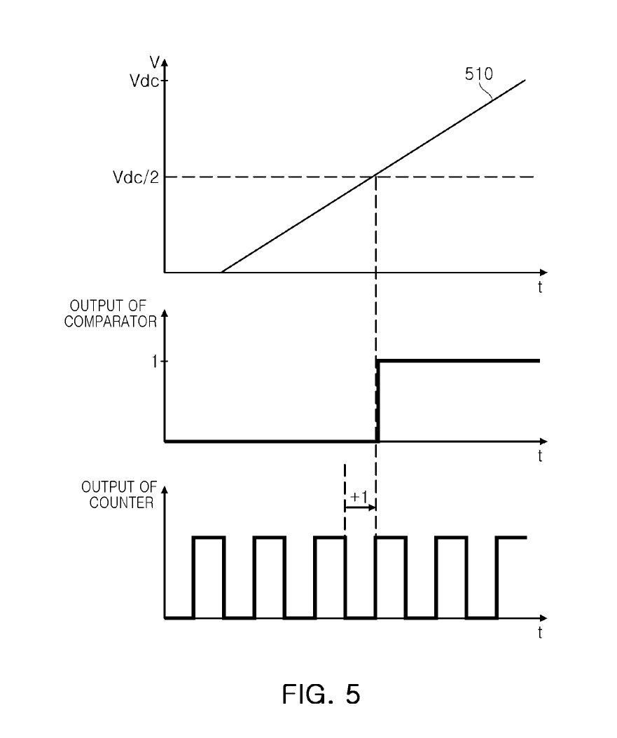

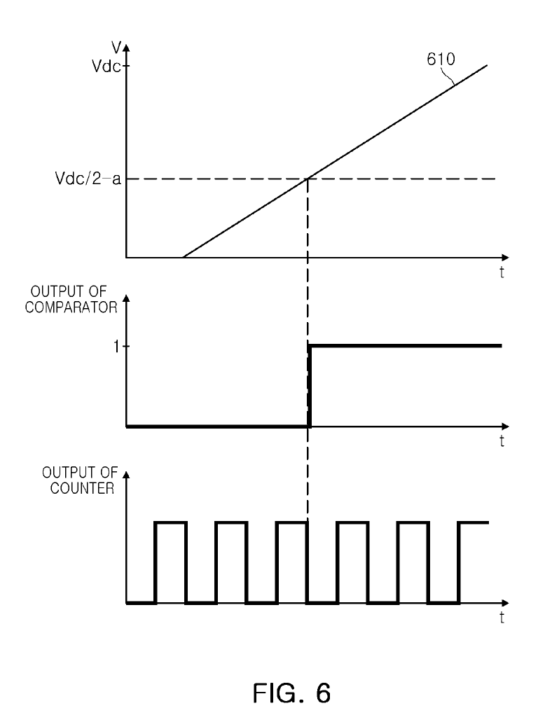

FIG. 4 is a detailed configuration diagram illustrating an example of an offset correcting unit of FIG. 3; and FIGS. 5 and 6 are reference graphs for describing offset correction by the offset correcting unit of FIG. 3.

Describing the example of the offset correcting unit in more detail with reference to FIGS. 3 through 6, the offset correcting unit 160 may include a standard voltage generator 161 and an offset controller 163. In another example, the offset correcting unit 160 may further include at least one of a counter 162, variable resistors 164 and 165, and a switch 165.

The standard voltage generator 161 may generate a linear standard voltage having a constant gradient. The standard voltage generator 161 may provide the generated standard voltage as an input signal (hereinafter, referred to as a first signal) of the comparator 141. The standard voltage may have a constant gradient, which is used to detect the offset delay of the comparator 141.

Here, the comparator 141 may be a component included in the back-electromotive force detecting unit 140. Therefore, an output of the comparator 141 may be back-electromotive force. In addition, the comparator 141 may receive a reference voltage as another input signal (hereinafter, referred to as a second signal). Here, the reference voltage may be a signal maintained to have a preset specific value.

The counter 162 may repeatedly generate a constant unit time. The counter 162 may provide the generated unit time to the offset controller 163.

The offset controller 163 may detect the offset delay of the comparator 141 using a change in the output of the comparator 141 over time. In addition, the offset controller 163 may change a resistance value of the variable resistor according to the detected offset delay, thereby correcting the offset delay.

The offset controller 163 will be described in more detail with reference to FIGS. 5 and 6.

FIG. 5 shows an example before offset correction is performed by the offset correcting unit; and FIG. 6 shows an example after the offset correction is performed by the offset correcting unit.

A standard voltage 510 and a reference voltage Vdc/2 shown in FIG. 5 may be input to two input terminals of the comparator 141, respectively. Therefore, as shown in output graphs of the comparator, in the case in which the standard voltage 510 is higher than the reference voltage Vdc, the comparator 141 may have 1 as an output value.

In addition, the counter 162 may repeatedly generate a constant unit time. When viewing a first graph based on the unit time as described above, it may be appreciated that six periods of unit time are required for the standard voltage 510 to arrive at Vdc; however, a point at which the output of the comparator 141 is changed is a point of a fourth period of the unit time. Considering that the reference signal is Vdc/2, it indicates that a delay corresponding to one unit time is generated. This delay may be a delay due to the offset voltage of the comparator 141, wherein the offset voltage may be a predetermined t axis (or V axis) intercept of the standard voltage 510 as shown in FIG. 5.

Therefore, the offset controller 163 may perform the above-mentioned operation to determine the offset delay. That is, the offset controller 163 may confirm a point at which the output of the comparator 141 is changed based on the output of the counter 162 and determine whether the delay has been generated based on the output of the counter 162, that is, the unit time.

When it is determined that the delay has been generated, the offset controller 163 may perform a control to vary the resistance value of the variable resistor in order to correct the delay. In the example shown in FIGS. 4 and 5, the offset controller 163 may vary the resistance component of the second variable resistor 165 connected to the reference voltage Vdc/2, that is, move the reference voltage Vdc/2 to the t axis in the graph of FIG. 5, thereby correcting the offset delay. (It is also obvious that the offset delay may be corrected by changing a gradient of the standard voltage 510 in another example).

FIG. 6 shows a waveform and a comparator output in which the offset delay is corrected by the offset controller 163.

It may be appreciated from FIG. 6 that the resistance of the second variable resistor 165 is varied by the offset controller 163, such that the reference voltage input to the comparator 141 is changed to ‘Vdc/2−a’. Therefore, it may be appreciated that a change in the output of the comparator 141 is also accurately corrected and the offset delay is corrected due to the above-mentioned correction.

In the embodiment of the present invention, the offset controller 163 may control the switch 166 such that a phase voltage is input as an input of the comparator 141 when the correction of the offset delay is completed. That is, the offset controller 163 may allow the standard voltage to be input as the input of the comparator 141 before the correction of the offset delay is performed and allow the input of the comparator 141 to be changed into the phase voltage in order to detect back-electromotive force after the correction of the offset delay is performed. To this end, the offset correcting unit 160 may include the switch 166 capable of selectively connecting either of the standard voltage and the phase voltage, and the offset controller 163 may provide a switching control signal such that the switch 166 is switched according to whether or not the offset delay has been corrected.

The variable resistor may be connected to an input terminal of the comparator 141. The variable resistor may vary the resistance value thereof according to the control of the offset controller 163 to correct the offset delay.

In the embodiment of the present invention, the variable resistors may be provided at both input terminals of the comparator 141, respectively. For example, the variable resistors may include a first variable resistor 164 connected to a first input terminal of the comparator 141 to which the standard voltage or the phase voltage is input and a second variable resistor 165 connected to a second input terminal of the comparator 141 to which the reference voltage is input. In the embodiment of the present invention as described above, the offset controller 163 may perform a control to vary a resistance value of at least one of the first variable resistor 164 and the second variable resistor 165 according to whether the offset delay has a positive (+) value or a negative (−) value, thereby correcting the offset delay.

In the embodiment of the present invention, the first and second variable resistors 164 and 165 may be configured in a ladder structure. For example, the ladder structure may include a plurality of resistors connected in series with each other and a plurality of switches connected in parallel with the plurality of resistors, respectively. Here, the plurality of switches may perform switching operations according to the switching control signal of the offset controller 163 to variably set the resistance value.

The switch 166 may be connected to one input terminal of the comparator 141 and be switched such that one of the standard voltage and the phase voltage of the motor apparatus 200 is input to the input terminal of the comparator 141.

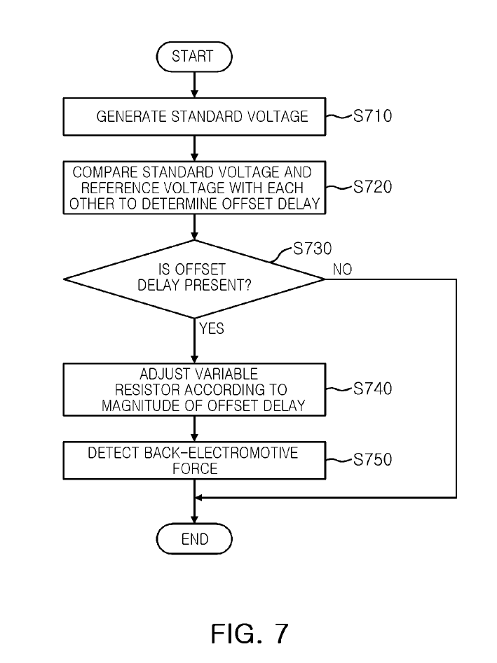

FIG. 7 is a flow chart for describing an example of a motor driving control method according to the embodiment of the present invention.

Hereinafter, an example of a motor driving control method according to the embodiment of the present invention will be described with reference to FIG. 7. Since the example of the motor driving control method according to the embodiment of the present invention is performed in the motor driving control apparatus 100 described above with reference to FIGS. 3 through 6, an overlapped description for contents that are the same as or correspond to the above-mentioned contents will be omitted.

Referring to FIG. 7, the motor driving control apparatus 100 may generate a linear standard voltage having a constant gradient (S710).

The motor driving control apparatus 100 may compare a reference voltage maintained to have a preset value with the standard voltage through the comparator and determine an offset delay of the comparator using an output of the comparator as described above (S720).

When the offset delay is present (S730), the motor driving control apparatus 100 may correct the offset delay of the comparator (S740).

In the embodiment of the present invention, the motor driving control apparatus 100 may detect back-electromotive force using the comparator of which the offset delay has been corrected (S750). More specifically, the motor driving control apparatus 100 may detect the back-electromotive force for the motor apparatus from the comparator of which the offset delay has been corrected and generate a driving control signal for the motor apparatus using the detected back-electromotive force.

In an example of 5720, the motor driving control apparatus 100 may detect an output of the comparator receiving the reference voltage maintained to have the preset value and the standard voltage and then determine the offset delay using a change in the output of the comparator for a predetermined standard unit time.

Here, the standard voltage may be a voltage increased to a preset value (first voltage) while having a constant gradient, and the reference voltage may correspond to ½ of the preset value (the first voltage). The motor driving control apparatus 100 may compare a first point at which the output value of the comparator is changed and a second point at which the standard voltage arrives at the first voltage with each other and determine that the offset delay is present when the first point does not correspond to ½ of the second point.

In an example of S740, the motor driving control apparatus 100 may change a resistance value of the variable resistor connected to the input terminal of the comparator to correct the offset delay.

As set forth above, according to the embodiments of the present invention, the offset delay of the comparator is detected using the standard voltage having the constant gradient and is actively corrected, whereby the motor apparatus may be more accurately controlled using the back-electromotive force in which the offset delay is corrected.

While the present invention has been shown and described in connection with the embodiments, it will be apparent to those skilled in the art that modifications and variations can be made without departing from the spirit and scope of the invention as defined by the appended claims.

What is claimed is:

1. A motor driving control apparatus comprising:
a back-electromotive force detecting unit detecting back-electromotive force generated from a motor apparatus;
an offset correcting unit determining whether an offset delay is present in the back-electromotive force detecting unit and correcting the offset delay when the offset delay is present; and
a controlling unit controlling a driving of the motor apparatus using the back-electromotive force in which the offset delay is corrected by the offset correcting unit.

2. The motor driving control apparatus of claim 1, wherein the back-electromotive force detecting unit includes a comparator receiving first and second signals, comparing the first and second signals with each other, and outputting a comparison result.

3. The motor driving control apparatus of claim 2, wherein the offset correcting unit corrects the offset delay generated by the comparator.

4. The motor driving control apparatus of claim 2, wherein the offset correcting unit includes a standard voltage generator generating a linear standard voltage having a constant gradient and providing the linear standard voltage as the first signal, and
the second signal is maintained to have a preset value.

5. The motor driving control apparatus of claim 2, wherein the offset correcting unit includes:
a standard voltage generator generating a linear standard voltage having a constant gradient and providing the linear standard voltage as the first signal; and
an offset controller detecting the offset delay of the comparator using a change in output of the comparator over time.

6. The motor driving control apparatus of claim 5, wherein the offset correcting unit further includes a variable resistor connected to an input terminal of the comparator, and
the offset controller changes a resistance value of the variable resistor according to the detected offset delay.

7. The motor driving control apparatus of claim 6, wherein the variable resistor includes:
a first variable resistor connected to a first input terminal of the comparator to which the first signal is input; and
a second variable resistor connected to a second input terminal of the comparator to which the second signal is input.

8. The motor driving control apparatus of claim 5, wherein the offset correcting unit further includes a switch switched such that one of the standard voltage and a phase voltage of the motor apparatus is input as the first signal, and
the offset controller controls the switch such that the phase voltage is input as the first signal when the correction of the offset delay is completed.

9. A motor comprising:
a motor apparatus performing a rotation operation according to a driving control signal; and
a motor driving control apparatus correcting an offset delay of a comparator for detecting back-electromotive force generated from the motor apparatus and generating the driving control signal using the back-electromotive force output from the comparator of which the offset delay is corrected.

10. The motor of claim 9, wherein the motor driving control apparatus includes:
a back-electromotive force detecting unit detecting the back-electromotive force generated from the motor apparatus using the comparator;
an offset correcting unit calculating the offset delay of the comparator and correcting the offset delay when the offset delay is present; and
a controlling unit controlling a driving of the motor apparatus using the back-electromotive force in which the offset delay is corrected by the offset correcting unit.

11. The motor of claim 10, wherein the offset correcting unit includes:
a standard voltage generator generating a linear standard voltage having a constant gradient and providing the linear standard voltage to the comparator; and
an offset controller detecting the offset delay of the comparator using a change in the output of the comparator over time.

12. The motor of claim 11, wherein the offset correcting unit further includes a variable resistor connected to an input terminal of the comparator, and
the offset controller changes a resistance value of the variable resistor according to the detected offset delay.

13. The motor of claim 11, wherein the offset correcting unit further includes a switch switched such that one of the standard voltage and a phase voltage of the motor apparatus is input to the comparator, and
the offset controller controls the switch such that the phase voltage is input to the comparator when the correction of the offset delay is completed.

14. A motor driving control method performed by a motor driving control apparatus controlling a driving of a motor apparatus, the motor driving control method comprising:
generating a linear standard voltage having a constant gradient;
determining an offset delay of a comparator by using an output of the comparator receiving a reference voltage maintained to have a preset value and the standard voltage; and
correcting the offset delay of the comparator when the offset delay is present.

15. The motor driving control method of claim 14, further comprising detecting back-electromotive force for the motor apparatus from the comparator of which the offset delay is corrected and generating a driving control signal for the motor apparatus using the detected back-electromotive force.

16. The motor driving control method of claim 14, wherein the determining of the offset delay includes:
detecting the output of the comparator receiving the reference voltage maintained to have the preset value and the standard voltage; and
determining the offset delay using a change in the output for a predetermined standard unit time.

17. The motor driving control method of claim 16, wherein the standard voltage is a voltage increased to a preset first voltage while having a constant gradient, and
the reference voltage corresponds to ½ that of the first voltage.

18. The motor driving control method of claim 17, wherein the determining of the offset delay using the change in the output includes:
comparing a first point at which an output value of the comparator is changed and a second point at which the standard voltage arrives at the first voltage with each other; and
determining that the offset delay is present when the first point does not correspond to ½ of the second point.

19. The motor driving control method of claim 14, wherein the correcting of the offset delay includes changing a resistance value of a variable resistor connected to an input terminal of the comparator to correct the offset delay.
